(19) United States
(12) Patent Application Publication
(10) Pub. No.: US 2009/0233916 A1
(43) Pub. Date: Sep. 17, 2009

(54) METHOD OF INDUCING VIRUS TOLERANCE OF PLANTS

(75) Inventors: Harald Köhle, Bobenheim (DE); Ted R. Bardinelli, Durham, NC (US); Marco-Antonio Tavares-Rodrigues, Jabaquara-Sao Paulo-Sao Paulo (BR)

Correspondence Address: BRINKS, HOFER, GILSON & LIONE, P.O. BOX 1340, MORRISVILLE, NC, 27560, US

(73) Assignee: BASF SE, Ludwigshafen (DE)

(21) Appl. No.: 12/281,007

(22) PCT Filed: Mar. 6, 2007
(86) PCT No.: PCT/EP07/52074

§ 371 Date: Aug. 28, 2008

Related U.S. Application Data
(60) Provisional application No. 60/782,242, filed on Mar. 14, 2006.

(51) Int. Cl. A01N 43/88; A01N 47/14

(52) U.S. Cl. 514/229.2; 514/491

(57) ABSTRACT

A method of inducing virus tolerance of plants which comprises treating the plants, the soil or seeds with an effective amount of a combination of a compound of the formula (I) in which the variables have the meaning as set forth in the description, and a second active compound as defined in the description; which is taken up by the plants or seeds.

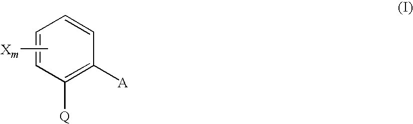

The present invention relates to a method of inducing virus tolerance of plants which comprises treating the plants, the soil or seeds with an effective amount of a combination of

1) a compound of the formula I

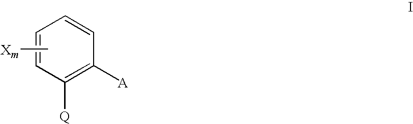

in which
X is halogen, C₁-C₄-alkyl or trifluoromethyl;
m is 0 or 1;
Q is C(═CH—CH₃)—COOCH₃, C(═CH—OCH₃)—COOCH₃, C(═N—OCH₃)—CONHCH₃, C(═N—OCH₃)—COOCH₃, N(—OCH₃)—COOCH₃, or a group Q1

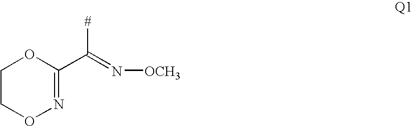

wherein # denotes the bond to the phenyl ring;
A is —O—B, —CH₂O—B, —OCH₂—B, —CH═CH—B, —C≡C—B, —CH₂O—N═C(R¹)—B, —CH₂O—N═C(R¹)—CH═CH—B, or —CH₂O—N═C(R¹)—C(R²)═N—OR³, where
B is phenyl, naphthyl, 5- or 6-membered hetaryl or 5- or 6-membered heterocyclyl, containing one to three N atoms and/or one O or S atom or one or two O and/or S atoms, the ring systems being unsubstituted or substituted by one to three radicals R^{a}:
   R^{a} is cyano, nitro, amino, aminocarbonyl, aminothiocarbonyl, halogen, C₁-C₆-alkyl, C₁-C₆-haloalkyl, C₁-C₆-alkylcarbonyl, C₁-C₆-alkylsulfonyl, C₁-C₆-alkylsulfinyl, C₃-C₆-cycloalkyl, C₁-C₆-alkoxy, C₁-C₆-haloalkoxy, C₁-C₆-alkyloxycarbonyl, C₁-C₆-alkylthio, C₁-C₆-alkylamino, di-C₁-C₆-alkylamino, C₁-C₆-alkylaminocarbonyl, di-C₁-C₆-alkylamino-carbonyl, C₁-C₆-alkylaminothiocarbonyl, di-C₁-C₆-alkylaminothiocarbonyl, C₂-C₆-alkenyl, C₂-C₆-alkenyloxy, phenyl, phenoxy, benzyl, benzyloxy, 5- or 6-membered heterocyclyl, 5- or 6-membered hetaryl, 5- or 6-membered hetaryloxy, C(═NOR^{a})—R^{b} or OC(R^{a})₂—C(R^{b})═NOR^{b},
      the cyclic radicals, in turn, being unsubstituted or substituted by one to three radicals R^{b}:
      R^{b} is cyano, nitro, halogen, amino, aminocarbonyl, aminothiocarbonyl, C₁-C₆-alkyl, C₁-C₆-haloalkyl, C₁-C₆-alkylsulfonyl, C₁-C₆-alkylsulfinyl, C₃-C₆-cycloalkyl, C₁-C₆-alkoxy, C₁-C₆-haloalkoxy, C₁-C₆-alkoxycarbonyl, C₁-C₆-alkylthio, C₁-C₆-alkylamino, di-C₁-C₆-alkylamino, C₁-C₆-alkylaminocarbonyl, di-C₁-C₆-alkylamino-carbonyl, C₁-C₆-alkylaminothiocarbonyl, di-C₁-C₆-alkylaminothiocarbonyl, C₂-C₆-alkenyl, C₂-C₆-alkenyloxy, C₃-C₆-cycloalkyl, C₃-C₆-cycloalkenyl, phenyl, phenoxy, phenylthio, benzyl, benzyloxy, 5- or 6-membered heterocyclyl, 5- or 6-membered hetaryl, 5- or 6-membered hetaryloxy or C(═NOR^{A})-R^{B};
R^{A}, R^{B} are hydrogen or C₁-C₆-alkyl;
R¹ is hydrogen, cyano, C₁-C₄-alkyl, C₁-C₄-haloalkyl, C₃-C₆-cycloalkyl, C₁-C₄-alkoxy;
R² is phenyl, phenylcarbonyl, phenylsulfonyl, 5- or 6-membered hetaryl, 5- or 6-membered hetarylcarbonyl or 5- or 6-membered hetarylsulfonyl, the ring systems being unsubstituted or substituted by one to three radicals R^{a},
   C₁-C₁₀-alkyl, C₃-C₆-cycloalkyl, C₂-C₁₀-alkenyl, C₂-C₁₀-alkynyl, C₁-C₁₀-alkylcarbonyl, C₂-C₁₀-alkenylcarbonyl, C₃-C₁₀-alkynylcarbonyl, C₁-C₁₀-alkylsulfonyl, or C(═NOR^{A})-R^{B}, the hydrocarbon radicals of these groups being unsubstituted or substituted by one to three radicals R^{c}:
   R^{c} is cyano, nitro, amino, aminocarbonyl, aminothiocarbonyl, halogen, C₁-C₆-alkyl, C₁-C₆-haloalkyl, C₁-C₆-alkylsulfonyl, C₁-C₆-alkylsulfinyl, C₁-C₆-alkoxy, C₁-C₆-haloalkoxy, C₁-C₆-alkoxycarbonyl, C₁-C₆-alkylthio, C₁-C₆-alkylamino, di-C₁-C₆-alkylamino, C₁-C₆-alkylaminocarbonyl, di-C₁-C₆-alkylaminocarbonyl, C₁-C₆-alkylaminothiocarbonyl, di-C₁-C₆-alkylaminothiocarbonyl, C₂-C₆-alkenyl, C₂-C₆-alkenyloxy,
      C₃-C₆-cycloalkyl, C₃-C₆-cycloalkyloxy, 5- or 6-membered heterocyclyl, 5- or 6-membered heterocyclyloxy, benzyl, benzyloxy, phenyl, phenoxy, phenylthio, 5- or 6-membered hetaryl, 5- or 6-membered hetaryloxy and hetarylthio, it being possible for the cyclic groups, in turn, to be partially or fully halogenated or to have attached to them one to three radicals R^{a}; and
R³ is hydrogen, C₁-C₆-alkyl, C₂-C₆-alkenyl, C₂-C₆-alkynyl, the hydrocarbon radicals of these groups being unsubstituted or substituted by one to three radicals R^{c};
   and

2) a compound selected from the groups A) to N):
A) acylalanines: benalaxyl, metalaxyl, ofurace, oxadixyl,
B) amine derivatives: aldimorph, dodine, dodemorph, fenpropimorph, fenpropidin, guazatine, iminoctadine, spiroxamine, tridemorph,
D) antibiotics: cycloheximid, griseofulvin, kasugamycin, natamycin, polyoxin or streptomycin,
E) azoles: bitertanol, bromoconazole, cyproconazole, difenoconazole, dinitroconazole, enilconazole, epoxiconazole, fenbuconazole, fluquinconazole, flusilazole, flutriafol, hexaconazole, imazalil, ipconazole, metconazole, myclobutanil, penconazole, propiconazole, prochloraz, prothioconazole, simeconazole, tebuconazole, tetraconazole, triadimefon, triadimenol, triflumizol, triticonazole,
G) dithiocarbamates: ferbam, nabam, maneb, mancozeb, metam, metiram, propineb, polycarbamate, thiram, ziram, zineb,
H) heterocyclic compounds: anilazine, benomyl, boscalid, carbendazim, carboxin, oxycarboxin, cyazofamid, dazomet, diflufenzopyr, dithianon, famoxadone, fenamidone, fenarimol, fuberidazole, flutolanil, furametpyr, isoprothiolane, mepronil, nuarimol, penthiopyrad, picobenzamid, probenazole, proquinazid, pyrifenox, pyroquilon, quinoxyfen, silthiofam, thiabendazole, thifluzamide, thiophanate-methyl, tiadinil, tricyclazole, triforine, 5-chloro-7-(4-methyl-piperidin-1-yl)-6-(2,4,6-trifluoro-phenyl)-[1,2,4]triazolo[1,5-a]pyrimidine, 4-difluoromethyl-2-methyl-thiazole-5-carboxylic acid-(4′-bromo-biphenyl-2-yl)-amide, 4-difluoromethyl-2-methyl-thiazole-5-carboxylic acid-(4′-trifluoromethyl-biphenyl-2-yl)-amide, 4-difluoromethyl-2-methyl-thiazole-5-carboxylic acid-(4′-chloro-3′-fluoro-biphenyl-2-yl)-amide, 3-difluoromethyl-1-methyl-pyrazole-4-carboxylic acid-(3′,4′-dichloro-4-fluoro-biphenyl-2-yl)-amide, 3-difluoromethyl-1-methyl-pyrazole-4-carboxylic acid-(3′,4′-dichloro-5-fluoro-biphenyl-2-yl)-amide, 3,4-dichloro-isothiazole-5-carboxylic acid (2-cyano-phenyl) amide, 3-[5-(4-chloro-phenyl)-2,3-dimethyl-isoxazolidin-3-yl]-pyridine, 2-butoxy-6-iodo-3-propyl-chromen-4-one, 3-(3-bromo-6-fluoro-2-methyl-indole-1-sulfonyl)-[1,2,4]triazole-1-sulfonic acid dimethylamide,
   (2-chloro-5-[1-(3-methyl-benzyloxyimino)-ethyl]-benzyl)-carbamic acid methyl ester, (2-chloro-5-[1-(6-methyl-pyridin-2-ylmethoxyimino)-ethyl]-benzyl)carbamic acid methyl ester,
I) sulfur, and copper fungicides, such as Bordeaux mixture, copper acetate, copper oxychloride, basic copper sulfate,
L) other fungicides, selected from acibenzolar-5-methyl, benthiavalicarb, carpropamid, chlorothalonil, cyflufenamid, cymoxanil, diclomezin, diclocymet, diethofencarb, edifenphos, ethaboxam, fenhexamid, fentin acetate, fenoxanil, ferimzone, fluazinam, phosphorous acid and its salts, fosetyl, fosetylaluminum, iprovalicarb, hexachlorobenzene, mandipropamid, metrafenone, pencycuron, propamocarb, phthalide, toloclofos-methyl, quintozene, zoxamide, N-(2-(4-[3-(4-Chloro-phenyl)-prop-2-ynyloxy]-3-methoxy-phenyl)ethyl)-2-methanesulfonylamino-3-methyl-butyramide, N-(2-(4-[3-(4-Chlorophenyl)-prop-2-ynyloxy]-3-methoxy-phenyl)-ethyl)-2-ethanesulfonylamino-3-methyl-butyramide, 3-(4-Chloro-phenyl)-3-(2-isopropoxy carbonylamino-3-methyl-butyrylamino)-propionic acid methyl ester,
M) sulfenic acid derivatives: captafol, captan, dichlofluanid, folpet, tolylfluanid, and
N) cinnamides and analogous compounds: dimethomorph, flumetover or flumorph,
   which components 1) and 2) are taken up by the plants or seeds. In addition, the invention generally relates to the use of the combinations of a compound of formula I and a compound of the group A) to N) for inducing the virus tolerance of plants.

A large number of representatives of the highly heterogeneous group of plant viruses (phytophages) are capable of attacking economically relevant plants; the symptoms of the damage range from morphological modifications to the death of the plants. The very many ways in which viruses are transmitted (for example mechanically via wounding, via seeds and pollen, or via vectors such as nematodes and insects), the problems of diagnosis and the lack of suitable active ingredients make the control of such viruses extraordinarily difficult; the emphasis is therefore on preventative and phytosanitary measures. Accordingly, preventing viral diseases in plants is an important aim in agriculture.

The search for methods for preventing viral diseases in plants has already yielded anti-viral active ingredients, some of which resemble nucleic acids. However, some of these substances generate mutants and inhibit the metabolism of nucleic acids and proteins in the host cells, giving rise to damage. In the field, these materials have only a small actual control effect.

In WO 01/082701 it is taught that strobilurin type fungicides have a stimulatory effect on the plants' intrinsic immune system against viruses. However, the effect is not always fully satisfactory.

Prior art does not teach that the known fungicides mentioned as component 2) in the outset might influence the plants' immune system against viruses.

It is an object of the present invention to provide a highly effective method which can be used broadly, which does not damage the plants and which brings about effective immunization of the plants against viral diseases at a reduced total amount of active compounds applied.

We have found that this object is achieved by the method defined at the outset. The above-mentioned strobilurines of formula I are known as fungicides and, in some cases, also as insecticides (EP-A 178 826; EP-A 253 213; WO 93/15046; WO 95/18789; WO 95/21153; WO 95/21154; WO 95/24396; WO 96/01256; WO 97/15552).

The active compounds according to the groups A) to N) mentioned above, their preparation and their action against harmful fungi are generally known in the art (cf.: http://www.hclrss.demon.co.uk/index.html; The Pesticide Manual, 10th Ed., BCPC, 1995):

4-Difluoromethyl-2-methyl-thiazole-5-carboxylic acid-(4′-bromo-biphenyl-2-yl)-amide, 4-Difluoromethyl-2-methyl-thiazole-5-carboxylic acid-(4′-trifluoromethyl-biphenyl-2-yl)amide, 4-Difluoromethyl-2-methyl-thiazole-5-carboxylic acid-(4′-chloro-3′-fluoro-biphenyl-2-yl)-amide, 3-Difluoromethyl-1-methyl-pyrazole-4-carboxylic acid-(3′,4′-dichloro-4-fluoro-biphenyl-2-yl)-amide (WO 03/066610), 3,4-Dichloro-isothiazole-5-carboxylic acid (2-cyano-phenyl) amide (WO 99/24413), N-(2-(4-[3-(4-Chloro-phenyl)-prop-2-ynyloxy]-3-methoxy-phenyl)-ethyl)-2-methanesulfonylamino-3-methyl-butyramide, N-(2-(4-[3-(4-Chloro-phenyl)-prop-2-ynyloxy]-3-methoxy-phenyl)-ethyl)-2-ethanesulfonylamino-3-methyl-butyramide (WO 04/049804), 3-[5-(4-Chloro-phenyl)-2,3-dimethyl-isoxazolidin-3-yl]-pyridine (EP-A 10 35 122), 2-Butoxy-6-iodo-3-propyl-chromen-4-one (WO 03/14103), 3-(3-Bromo-6-fluoro-2-methyl-indole-1-sulfonyl)-[1,2,4]triazole-1-sulfonic acid dimethylamide (EP-A 10 31 571), (2-Chloro-5-[1-(3-methyl-benzyloxyimino)-ethyl]-benzyl)-carbamic acid methyl ester, 2-Chloro-5-[1-(6-methyl-pyridin-2-ylmethoxyimino)-ethyl]-benzyl)-carbamic acid methyl ester (EP-A 12 01 648), 3-(4-Chloro-phenyl)-3-(2-isopropoxy carbonylamino-3-methyl-butyrylamino)-propionic acid methyl ester (EP-A 10 28 125).

The compounds identified by their common names are commercially available.

The publications cited at the outset describe synthesis routes for the preparation of the active ingredients used in the method according to the invention.

The good compatibility, with plants, of the active ingredients of the formula I at the concentrations required for controlling plant diseases permits the treatment of aerial plant parts and also the treatment of propagation material and seed, and of the soil.

In the method according to the invention, the active ingredients are taken up by the plant either through the leaf surface or through the roots and is distributed within the entire plant in the sap.

Thus, the protective action after carrying out the method according to the invention is not just found in those plant parts, which have been sprayed directly, but the tolerance to viral diseases of the entire plant is increased.

In a preferred embodiment of the method, the aerial plant parts are treated with a formulation or with a tank mix of the active ingredients 1) and 2).

Especially preferred for the method according to the invention are active ingredients with the following meanings of the substituents, in each case alone or in combination, the disclosure of the publications cited being hereby incorporated:

Especially preferred for the method according to the invention are, as component 1, the active ingredients of the formulae II to VIII, in which

### V is OCH₃ and NHCH₃,

### Y is CH and N and

T and Z independently of one another are CH and N.

Preferred active ingredients of the formula I in which Q is N(—OCH₃)—COOCH₃ are the compounds described in the publications WO 93/15046 and WO 96/01256.

Preferred active ingredients of the formula I in which Q is C(═CH—OCH₃)—COOCH₃ are the compounds described in the publications EP-A 178 826 and EP-A 278 595.

Preferred active ingredients of the formula I in which Q is C(═N—OCH₃)—COOCH₃ are the compounds described in the publications EP-A 253 213 and EP-A 254 426.

Preferred active ingredients of the formula I in which Q is C(═N—OCH₃)—CONHCH₃ are the compounds described in the publications EP-A 398 692, EP-A 477 631 and EP-A 628 540.

Preferred active ingredients of the formula I in which Q is C(═CH—CH₃)—COOCH₃ are the compounds described in the publications EP-A 280 185 and EP-A 350 691.

Preferred active ingredients of the formula I in which Q is —CH₂O—N═C(R¹)—B are the compounds described in the publications EP-A 460 575 and EP-A 463 488.

Preferred active ingredients of the formula I in which A is —O—B are the compounds described in the publications EP-A 382 375 and EP-A 398 692.

Preferred active ingredients of the formula I in which A is —CH₂O—N═C(R¹)—C(R²)═N—OR³ are the compounds described in the publications WO 95/18789, WO 95/21153, WO 95/21154, WO 97/05103 and WO 97/06133.

Especially preferred are the active ingredients of the formula I in which

### Q is N(—OCH₃)—COOCH₃,

### A is CH₂—O— and

B is 3-pyrazolyl or 1,2,4-triazolyl, where B has attached to it one or two substituents selected from the group of
halogen, methyl and trifluoromethyl and
phenyl and pyridyl, in particular 2-pyridyl, substituted by 1 to 3 radicals R^{b}.

These active ingredients are described by formula II,

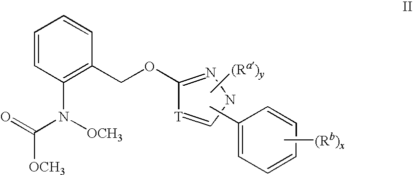

in which T is a carbon or a nitrogen atom, R^{a′} is halogen, methyl and trifluoromethyl, y is zero, 1 or 2, R^{b} is as defined for formula I, x is zero, 1, 2, 3 or 4.

More preferred active ingredients are those of formula II′:

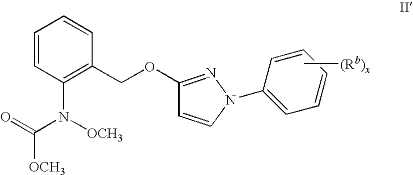

in which R^{b} is as defined for formula I.

With regard to their use, the compounds compiled in the tables, which follow, are especially preferred.

TABLE I

| | |
|---|---|
| | II |
| 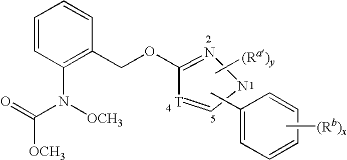 | |

| | | | Position of the group | | |
|---|---|---|---|---|---|
| No. | T | (R^{a′})_{y} | phenyl-(R^{b})ₓ | (R^{b})ₓ | Reference |
| I-1 | N | — | 1 | 2,4-Cl₂ | WO 96/01256 |
| I-2 | N | — | 1 | 4-Cl | WO 96/01256 |
| I-3 | CH | — | 1 | 2-Cl | WO 96/01256 |
| I-4 | CH | — | 1 | 3-Cl | WO 96/01256 |
| I-5 | CH | — | 1 | 4-Cl | WO 96/01256 |
| I-6 | CH | — | 1 | 4-CH₃ | WO 96/01256 |
| I-7 | CH | — | 1 | H | WO 96/01256 |
| I-8 | CH | — | 1 | 3-CH₃ | WO 96/01256 |
| I-9 | CH | 5-CH₃ | 1 | 3-CF₃ | WO 96/01256 |
| I-10 | CH | 1-CH₃ | 5 | 3-CF₃ | WO 99/33812 |
| I-11 | CH | 1-CH₃ | 5 | 4-Cl | WO 99/33812 |
| I-12 | CH | 1-CH₃ | 5 | — | WO 99/33812 |

TABLE II

| | |
|---|---|
| | III |
| 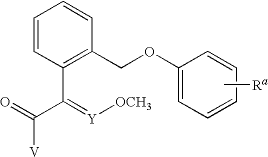 | |

| No. | V | Y | R^{a} | Reference |
|---|---|---|---|---|
| II-1 | OCH₃ | N | 2-CH₃ | EP-A 253 213 |
| II-2 | OCH₃ | N | 2,5-(CH₃)₂ | EP-A 253 213 |
| II-3 | NHCH₃ | N | 2,5-(CH₃)₂ | EP-A 477 631 |
| II-4 | NHCH₃ | N | 2-Cl | EP-A 398 692 |
| II-5 | NHCH₃ | N | 2-CH₃ | EP-A 398 692 |
| II-6 | NHCH₃ | N | 2-CH₃, 4-OCF₃ | EP-A 628 540 |
| II-7 | NHCH₃ | N | 2-Cl, 4-OCF₃ | EP-A 628 540 |
| II-8 | NHCH₃ | N | 2-CH₃, 4-OCH(CH₃)—C(CH₃)═NOCH₃ | EP-A 11 18 609 |
| II-9 | NHCH₃ | N | 2-Cl, 4-OCH(CH₃)—C(CH₃)═NOCH₃ | EP-A 11 18 609 |
| II-10 | NHCH₃ | N | 2-CH₃, 4-OCH(CH₃)—C(CH₂CH₃)═NOCH₃ | EP-A 11 18 609 |
| II-11 | OCH₃ | CH | 2,5-(CH₃)₂ | EP-A 226 917 |

TABLE III

| | |
|---|---|
| | IV |
| 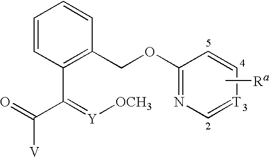 | |

| No. | V | Y | T | R^{a} | Reference |
|---|---|---|---|---|---|
| III-1 | OCH₃ | CH | N | 2-OCH₃, 4-CF₃ | WO 96/16047 |
| III-2 | OCH₃ | CH | N | 2-OCH(CH₃)₂, 4-CF₃ | WO 96/16047 |
| III-3 | OCH₃ | CH | CH | 2-CF₃ | EP-A 278 595 |
| III-4 | OCH₃ | CH | CH | 4-CF₃ | EP-A 278 595 |
| III-5 | NHCH₃ | N | CH | 2-Cl | EP-A 398 692 |
| III-6 | NHCH₃ | N | CH | 2-CF₃ | EP-A 398 692 |
| III-7 | NHCH₃ | N | CH | 2-CF₃, 4-Cl | EP-A 398 692 |
| III-8 | NHCH₃ | N | CH | 2-Cl, 4-CF₃ | EP-A 398 692 |

TABLE IV

| | |
|---|---|
| | V |
| 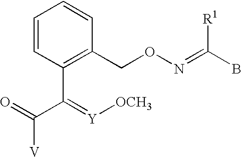 | |

| No. | V | Y | R¹ | B | Reference |
|---|---|---|---|---|---|
| IV-1 | OCH₃ | CH | CH₃ | (3-CF₃)C₆H₄ | EP-A 370 629 |
| IV-2 | OCH₃ | CH | CH₃ | (3,5-Cl₂)C₆H₃ | EP-A 370 629 |
| IV-3 | NHCH₃ | N | CH₃ | (3-CF₃)C₆H₄ | WO 92/13830 |
| IV-4 | NHCH₃ | N | CH₃ | (3-OCF₃)C₆H₄ | WO 92/13830 |
| IV-5 | OCH₃ | N | CH₃ | (3-OCF₃)C₆H₄ | EP-A 460 575 |
| IV-6 | OCH₃ | N | CH₃ | (3-CF₃)C₆H₄ | EP-A 460 575 |
| IV-7 | OCH₃ | N | CH₃ | (3,4-Cl₂)C₆H₃ | EP-A 460 575 |
| IV-8 | OCH₃ | N | CH₃ | (3,5-Cl₂)C₆H₃ | EP-A 463 488 |
| IV-9 | OCH₃ | CH | CH₃ | CH═CH-(4-Cl)C₆H₄ | EP-A 936 213 |

TABLE V

| | |
|---|---|
| | VI |
| 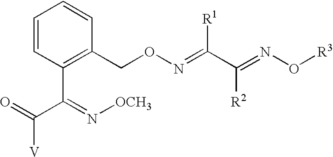 | |

| No. | V | R¹ | R² | R³ | Reference |
|---|---|---|---|---|---|
| V-1 | OCH₃ | CH₃ | CH₃ | CH₃ | WO |
| | | | | | 95/18789 |
| V-2 | OCH₃ | CH₃ | CH(CH₃)₂ | CH₃ | WO |
| | | | | | 95/18789 |
| V-3 | OCH₃ | CH₃ | CH₂CH₃ | CH₃ | WO |
| | | | | | 95/18789 |
| V-4 | NHCH₃ | CH₃ | CH₃ | CH₃ | WO |
| | | | | | 95/18789 |
| V-5 | NHCH₃ | CH₃ | 4-F—C₆H₄ | CH₃ | WO |
| | | | | | 95/18789 |
| V-6 | NHCH₃ | CH₃ | 4-Cl—C₆H₄ | CH₃ | WO |
| | | | | | 95/18789 |
| V-7 | NHCH₃ | CH₃ | 2,4-C₆H₃ | CH₃ | WO |
| | | | | | 95/18789 |
| V-8 | NHCH₃ | Cl | 4-F—C₆H₄ | CH₃ | WO |
| | | | | | 98/38857 |
| V-9 | NHCH₃ | Cl | 4-Cl—C₆H₄ | CH₂CH₃ | WO |
| | | | | | 98/38857 |
| V-10 | NHCH₃ | CH₃ | CH₂C(═CH₂)CH₃ | CH₃ | WO |
| | | | | | 97/05103 |
| V-11 | NHCH₃ | CH₃ | CH═C(CH₃)₂ | CH₃ | WO |
| | | | | | 97/05103 |
| V-12 | NHCH₃ | CH₃ | CH═C(CH₃)₂ | CH₂CH₃ | WO |
| | | | | | 97/05103 |
| V-13 | NHCH₃ | CH₃ | CH═C(CH₃)CH₂CH₃ | CH₃ | WO |
| | | | | | 97/05103 |
| V-14 | NHCH₃ | CH₃ | O—CH(CH₃)₂ | CH₃ | WO |
| | | | | | 97/06133 |
| V-15 | NHCH₃ | CH₃ | O—CH₂CH(CH₃)₂ | CH₃ | WO |
| | | | | | 97/06133 |
| V-16 | NHCH₃ | CH₃ | C(CH₃)═NOCH₃ | CH₃ | WO |
| | | | | | 97/15552 |

TABLE VI

| | |
|---|---|
| | VII |
| 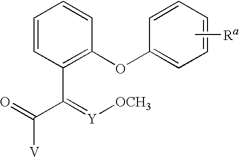 | |

| No. | V | Y | R^{a} | Reference |
|---|---|---|---|---|
| VI-1 | NHCH₃ | N | H | EP-A 398 692 |
| VI-2 | NHCH₃ | N | 3-CH₃ | EP-A 398 692 |
| VI-3 | NHCH₃ | N | 2-NO₂ | EP-A 398 692 |
| VI-4 | NHCH₃ | N | 4-NO₂ | EP-A 398 692 |
| VI-5 | NHCH₃ | N | 4-Cl | EP-A 398 692 |
| VI-6 | NHCH₃ | N | 4-Br | EP-A 398 692 |

TABLE VII

| | |
|---|---|
| | VIII |
| 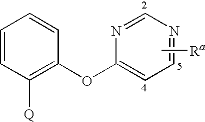 | |

| No. | Q | R^{a} | Reference |
|---|---|---|---|
| VII-1 | C(═CH—OCH₃)COOCH₃ | 5-O-(2-CN—C₆H₄) | EP-A 382 375 |
| VII-2 | C(═CH—OCH₃)COOCH₃ | 5-O-(2-Cl—C₆H₄) | EP-A 382 375 |
| VII-3 | C(═CH—OCH₃)COOCH₃ | 5-O-(2-CH_{3—C}₆H₄) | EP-A 382 375 |
| VII-4 | C(═N—OCH₃)CONHCH₃ | 5-O-(2-Cl—C₆H₄) | GB-A 2253624 |
| VII-5 | C(═N—OCH₃)CONHCH₃ | 5-O-(2,4 Cl₂—C₆H₃) | GB-A 2253624 |
| VII-6 | C(═N—OCH₃)CONHCH₃₃ | 5-O-(2-CH₃—C₆H₄) | GB-A 2253624 |
| VII-7 | C(═N—OCH₃)CONHCH₃ | 5-O-(2-CH₃, 3-Cl—C₆H₃) | GB-A 2253624 |
| VII-8 | C(═N—OCH₃)CONHCH₃ | 4-F, 5-O-(2-CH₃—C₆H₄) | WO 98/21189 |
| VII-9 | C(═N—OCH₃)CONHCH₃ | 4-F, 5-O-(2-Cl—C₆H₄) | WO 98/21189 |
| VII-10 | C(═N—OCH₃)CONHCH₃ | 4-F, 5-O-(2-CH₃, 3-Cl—C₆H₃) | WO 98/21189 |
| VII-11 | Q1 | 4-F, 5-O-(2-Cl—C₆H₄) | WO 97/27189 |
| VII-12 | Q1 | 4-F, 5-O-(2-CH₃, 3-Cl—C₆H₃) | WO 97/27189 |
| VII-13 | Q1 | 4-F, 5-O-(2,4-Cl₂—C₆H₃) | WO 97/27189 |

Particularly preferred are combinations of one of the following components 1: Compound I-5 (pyraclostrobin), II-1 (kresoxim-methyl), II-3 (dimoxystrobin), II-11 (ZJ 0712), III-3 (picoxystrobin), IV-6 (trifloxystrobin), IV-9 (enestroburin), V-16 (orysastrobin), VI-1 (metominostrobin), VII-1 (azoxystrobin), and VII-11 (fluoxastrobin) with one of the compounds selected from the groups A) to N).

A preferred embodiment of the invention are combinations of one of the compounds of formula I with one of the following compounds:
A) acylalanines, such as benalaxyl, metalaxyl, ofurace, oxadixyl,
B) amine derivatives, such as aldimorph, dodine, dodemorph, fenpropimorph, fenpropidin, guazatine, iminoctadine, spiroxamine, tridemorph,
D) antibiotics, such as cycloheximid, griseofulvin, kasugamycin, natamycin, polyoxin or streptomycin,
E) azoles, such as bitertanol, bromoconazole, cyproconazole, difenoconazole, dinitroconazole, enilconazole, epoxiconazole, fenbuconazole, fluquinconazole, flusilazole, flutriafol, hexaconazole, imazalil, ipconazole, metconazole, myclobutanil, penconazole, propiconazole, prochloraz, prothioconazole, simeconazole, tebuconazole, tetraconazole, triadimefon, triadimenol, triflumizol, triticonazole,
G) dithiocarbamates, such as ferbam, nabam, maneb, mancozeb, metam, metiram, propineb, polycarbamate, thiram, ziram, zineb,
H) heterocyclic compounds, such as anilazine, benomyl, boscalid, carbendazim, carboxin, oxycarboxin, cyazofamid, dazomet, diflufenzopyr, dithianon, famoxadone, fenamidone, fenarimol, fuberidazole, flutolanil, furametpyr, isoprothiolane, mepronil, nuarimol, penthiopyrad, picobenzamid, probenazole, proquinazid, pyrifenox, pyroquilon, quinoxyfen, silthiofam, thiabendazole, thifluzamide, thiophanate-methyl, tiadinil, tricyclazole, triforine, 5-Chloro-7-(4-methyl-piperidin-1-yl)-6-(2,4,6-trifluoro-phenyl)-[1,2,4]triazolo[1,5-a]pyrimidine,
I) sulfur, and copper fungicides, such as Bordeaux mixture, copper acetate, copper oxychloride, basic copper sulfate,
L) other fungicides, such as acibenzolar-5-methyl, benthiavalicarb, carpropamid, chlorothalonil, cyflufenamid, cymoxanil, diclomezin, diclocymet, diethofencarb, edifenphos, ethaboxam, fenhexamid, fentin acetate, fenoxanil, ferimzone, fluazinam, phosphorous acid and ist salts, fosetyl, fosetyl-aluminum, iprovalicarb, hexachlorobenzene, mandipropamid, metrafenone, pencycuron, propamocarb, phthalide, toloclofos-methyl, quintozene, zoxamide,
M) sulfenic acid derivatives, such as captafol, captan, dichlofluanid, folpet, tolylfluanid, and
N) cinnamides and analogous compounds, such as dimethomorph, flumetover or flumorph,

More preferably the method is carried out with a compound of formula I as defined above and a compound selected from the following groups:
A) acylalanines, especially benalaxyl, metalaxyl, ofurace, oxadixyl,
B) amine derivatives, especially dodine, fenpropimorph, tridemorph,
D) antibiotics, especially cycloheximid, griseofulvin, kasugamycin, natamycin, polyoxin or streptomycin,
E) azoles, especially epoxiconazole, fluquinconazole, flutriafol, imazalil, metconazole, prochloraz, tebuconazole, triticonazole,
G) dithiocarbamates, especially ferbam, nabam, maneb, mancozeb, metam, metiram, propineb, polycarbamate, thiram, ziram, zineb,
H) heterocyclic compounds, especially anilazine, benomyl, boscalid, carbendazim, carboxin, oxycarboxin, cyazofamid, dithianon, flutolanil, thiabendazole, thiophanate-methyl, 5-chloro-7-(4-methyl-piperidin-1-yl)-6-(2,4,6-trifluoro-phenyl)-[1,2,4]triazolo[1,5-a]pyrimidine,
I) copper fungicides, especially Bordeaux mixture, copper acetate, copper oxychloride, basic copper sulfate,
L) other fungicides, especially acibenzolar-5-methyl, benthiavalicarb, carpropamid, chlorothalonil, cyflufenamid, cymoxanil, ethaboxam, phosphorous acid and its alkali- and earth alkali salts, fosetyl, fosetyl-aluminum, metrafenone,
M) sulfenic acid derivatives, especially folpet, and
N) cinnamides and analogous compounds, especially dimethomorph.

Particular preference is given to combinations containing as component 2) one of the following compounds:
D) antibiotics, especially cycloheximid, griseofulvin, kasugamycin, natamycin, polyoxin or streptomycin,
G) dithiocarbamates, especially mancozeb, metiram,
H) heterocyclic compounds, especially carbendazim, dithianon, thiophanate-methyl,
I) copper fungicides,
L) other fungicides, especially acibenzolar-5-methyl, phosphorous acid and its alkali- and earth alkali salts,

Particularly useful is the combination of a compound of formula I with antibiotics, especially cycloheximid, griseofulvin, kasugamycin, natamycin, polyoxin or streptomycin.

Also particularly useful is the combination of a compound of formula I with dithiocarbamates, especially mancozeb, or metiram.

Furthermore particularly useful is the combination of a compound of formula I with heterocyclic compounds, especially carbendazim, dithianon, or thiophanate-methyl.

In addition, particularly useful is the combination of a compound of formula I with copper fungicides.

Also particularly useful is the combination of a compound of formula I with acibenzolarS-methyl, or phosphorous acid, and its alkali- or earth alkali salts.

The combinations of compounds 1) and 2) increase the tolerance of plants to viruses. They are especially important for controlling viruses on diverse crop plants such as tobacco, barley, cucumber, potatoes and beet, and on the seeds of these plants.

The inventive method is useful to induce tolerance in plants against viruses of various families, such as Avsunviroidae, Bromoviridae, Closteroviridae, Flexiviridae, Geminiviridae, Luteoviridae, Nanoviridae, Partitiviridae, Pospiviroidae, Potyviridae, Reoviridae, Mononegavirales, Rhabdoviridae, Sequiviridae, Tombusviridae, and Tymoviridae.

It is particularly suitable to control the following genus: Benyvirus, llarvirus, Cucumovirus, Oleavirus, Tospovirus, Caulimovirus, Soymovirus, Cavemovirus, Petuvirus; Closterovirus; Comovirus; Crinivirus, Ampelovirus, Fabavirus, Nepovirus, Allexivirus, Manadrivirus, Carlavirus, Capillovirus, Foveavirus, Potexvirus, Trichovirus, Vitivirus, Furovirus, Mastrevirus, Curtovirus, Begomovirus, Hordeivirus, Idaeovirus, Luteovirus, Polerovirus, Enamovirus, Nanovirus, Ophiovirus, Ourmiavirus, Alphacryptovirus, Betacryptovirus, Pecluvirus, Pomovirus, Potyvirus, Rymovirus, Bymovirus, Macluravirus, Ipomovirus, Tritimovirus, Fijivirus, Phytoreovirus, Oryzavirus, Cytorhabdovirus, Nucleorhabdovirus, Sequivirus, Waikavirus, Sobemovirus, Tenuivirus, Tobamovirus, Tobravirus, Tombusvirus, Carmovirus, Necrovirus, Dianthovirus, Machlomovirus, Avenavirus, Tymovirus, Marafivirus, Maculavirus, Umbravirus, Varicosavirus, Pospiviroid, Hostuviroid, Cocadviroid, Apscaviroid, Coleviroid, Avsuniviroid, and Pelamoviroid.

More particularly, the inventive method is useful for controlling the following species: Tobacco streak virus, Cucumber mosaic virus, Tomato spotted wilt virus, Soybean chlorotic mottle virus, Broad bean wilt virus 1, Tobacco ringspot virus, Potato virus X, Soil-borne wheat mosaic virus, Barley stripe mosaic virus, Potato leafroll virus, Ourmia melon virus, Peanut clump virus, Potato mop-top virus, Potato virus Y, Barley yellow mosaic virus, Wheat streak mosaic virus, Potato yellow dwarf virus, Tobacco necrosis virus satellite, Southern bean mosaic virus, Tobacco mosaic virus, Tobacco rattle virus, Tomato bushy stunt virus, Tobacco necrosis virus A, Maize chlorotic mottle virus, Maize rayado fino virus, and Potato spindle tuber viroid.

Specifically, they are suitable for controlling the following plant diseases:
in tobacco, the tobacco mosaic virus and the tobacco necrosis virus,
in beans, the bean common mosaic virus and the bean yellow mosaic virus,
in barley, the barley stripe mosaic virus and the barley yellow dwarf virus (DYDV),
in cucumbers, the cucumber green mottle mosaic virus and the cucumber mosaic virus,
in potatoes, the potato X virus and the potato y virus,
in beet, rhizomania and beet mild yellowing virus.

The compounds are applied by treating the soil or the seeds or plants to be protected against viral attack with an effective amount of the active ingredients. Application can be effected both before and after infection of the plants or seeds by the viruses. In a preferred embodiment of the invention the application is made as preventive application.

The application of the compounds 1) and 2) preferably is made during the first six weeks, preferably four weeks of the growth period of the plants, long before first protective application against fungi usually is made.

The plant is treated before infection takes place, preferably several weeks to one week before the expected virus attack. During such timeframe one to 10 applications are carried out. A markedly reduced susceptibility of the plant to viral diseases is observed.

In case of vegetables and field crops the active ingredients are preferably applied shortly after germination of the plants, especially within the first four weeks after germination. In case of fruits and other perennial plants the first application is made before begin or within the first four weeks of the growth period. In all cases best efficacy is observed, when the application is repeated every 10 to 20 days.

The method according to the invention is preferably carried out as foliar application when applied to fruit and vegetables, such as potatoes, tomatoes, cucurbits, preferably cucumbers, melons, watermelons, garlic, onions, and lettuce. Preferably more than two applications, and up to 10 applications during a season are carried out.

The method according to the invention is preferably carried out as foliar application when applied to fruits, such as apples, stone fruits, and citrus. Preferably more than two applications, and up to 5 applications during a season are carried out.

The method of the invention can also be applied to field crops, such as soybeans, corn, cotton, tobacco, common beans, wheat, barley, peas, and others. In relation to these crops the method is preferably applied by treating the seeds or the plants. The plants are preferably treated with two to three applications.

The component 1) and the component 2) can be applied simultaneously, that is jointly or separately, or in succession, the sequence, in the case of separate application, generally not having any effect on the result of the control measures.

In one embodiment of the mixtures according to the invention, a further active compound 3) or two active compounds 3) and 4) are added to the components 1) and 2). Suitable compounds 3) and 4) are selected from the compounds mentioned as component 2).

Preference is given to mixtures of the components 1) and 2) and a component 3). Particular preference is given to mixtures of the components 1) and 2).

The ratio in which component 1) and the component 2) are applied depends from the specific compound 1) and compound 2), usually they are applied in a weight ratio of from 1000:1 to 1:1000, preferable 100:1 to 1:100, more preferably from 20:1 to 1:20, in particular from 10:1 to 1:10.

In a preferred embodiment a synergistically increased preventive effect against viruses is observed.

For use in crop protection, the application rates are between 0.01 and 2.0 kg, preferably up to 1.0 kg of active ingredient per hectare, depending on the type of pathogen and the plant species.

In the treatment of seed, amounts of from 0.001 to 0.1 g, preferably 0.01 to 0.05 g, of active ingredient are generally required per kilogram of seed.

If diflufenzopyr is used as component 2) it is used in very low doses, the weight ratio in such case is preferably of from 1000:1 to 30:1, preferably from 1000:1 to 50:1, especially 500:1 to 100:1.

Depending on the type of plant to be protected, the application rate of diflufenzopyr is 50 mg to 10 g/ha, preferably from 100 mg to 2 g/ha.

For protecting monocotyledonous plants amounts of 100 mg to 10 g/ha, preferably between 100 mg and 5 g/ha diflufenzopyr are sufficient to enhance resistibility of the plants.

For protecting dicotyledonous plants amounts of 50 mg to 5 g/ha, preferably 100 mg to 2 g/ha diflufenzopyr are used.

The components 3) and, if appropriate, 4) are, if desired, added in a ratio of 20:1 to 1:20 to the component 1).

Depending on the type of compound and the desired effect, the application rates of the mixtures according to the invention are from 5 g/ha to 1000 g/ha, preferably from 50 to 900 g/ha, in particular from 50 to 750 g/ha.

Correspondingly, the application rates for the component 1) are generally from 1 to 11000 g/ha, preferably from 10 to 900 g/ha, in particular from 20 to 750 g/ha.

Correspondingly, the application rates for the component 2) are generally from 1 to 1000 g/ha, preferably from 10 to 500 g/ha, in particular from 40 to 350 g/ha.

In the treatment of seed, application rates of mixture are generally from 1 to 1000 g/100 kg of seed, preferably from 1 to 200 g/00 kg, in particular from 5 to 100 g/100 kg.

The mixtures according to the invention, or the components 1) and 2), can be converted into the customary formulations, for example solutions, emulsions, suspensions, dusts, powders, pastes and granules. The use form depends on the particular intended purpose; in each case, it should ensure a fine and even distribution of the compound according to the invention.

Best results are obtained when a formulation is used which supports the transport of the active compounds into the plants, and the distribution within the entire plant in the sap. Such especially suitable formulations are, e.g. EC, DC, and SE.

The compounds 1) and 2) can be used as such, in the form of their formulations or the use forms prepared therefrom, for example in the form of directly sprayable solutions, powders, suspensions or dispersions, emulsions, oil dispersions, pastes, dustable products, materials for spreading, or granules, by means of spraying, atomizing, dusting, spreading or pouring. The use forms depend entirely on the intended purposes; they are intended to ensure in each case the finest possible distribution of the active compound(s) according to the invention.

Aqueous use forms can be prepared from emulsion concentrates, pastes or wettable powders (sprayable powders, oil dispersions) by adding water. To prepare emulsions, pastes or oil dispersions, the substances, as such or dissolved in an oil or solvent, can be homogenized in water by means of a wetter, tackifier, dispersant or emulsifier. However, it is also possible to prepare concentrates composed of active substance, wetter, tackifier, dispersant or emulsifier and, if appropriate, solvent or oil, and such concentrates are suitable for dilution with water.

The active compound concentrations in the ready-to-use preparations can be varied within relatively wide ranges. In general, they are from 0.0001 to 10%, preferably from 0.01 to 1% per weight.

The active compound may also be used successfully in the ultra-low-volume process (ULV), it being possible to apply formulations comprising over 95% by weight of active compound, or even to apply the active compound without additives.

The formulations are prepared in a known manner (see e.g. for review U.S. Pat. No. 3,060,084, EP-A 707 445 (for liquid concentrates), Browning, “Agglomeration”, Chemical Engineering, Dec. 4, 1967, 147-48, Perry's Chemical Engineer's Handbook, 4th Ed., McGraw-Hill, New York, 1963, pages 8-57 and et seq. WO 91/13546, U.S. Pat. No. 4,172,714, U.S. Pat. No. 4,144,050, U.S. Pat. No. 3,920,442, U.S. Pat. No. 5,180,587, U.S. Pat. No. 5,232,701, U.S. Pat. No. 5,208,030, GB 2,095,558, U.S. Pat. No. 3,299,566, Klingman, Weed Control as a Science, John Wiley and Sons, Inc., New York, 1961, Hance et al., Weed Control Handbook, 8th Ed., Blackwell Scientific Publications, Oxford, 1989 and Mollet, H., Grubemann, A., Formulation technology, Wiley VCH Verlag GmbH, Weinheim (Germany), 2001, 2. D. A. Knowles, Chemistry and Technology of Agrochemical Formulations, Kluwer Academic Publishers, Dordrecht, 1998 (ISBN 0-7514-0443-8), for example by extending the active compound with auxiliaries suitable for the formulation of agrochemicals, such as solvents and/or carriers, if desired emulsifiers, surfactants and dispersants, preservatives, anti-foaming agents, anti-freezing agents. The use of formulations of copper salts which contain basic amino acids, lysin, polylysin, or polylysin derivatives represents is one embodiment of the current invention.

Examples of suitable solvents are water, aromatic solvents (for example Solvesso products, xylene), paraffins (for example mineral oil fractions), alcohols (for example methanol, butanol, pentanol, benzyl alcohol), ketones (for example cyclohexanone, gamma-butyrolactone), pyrrolidones (NMP, NOP), acetates (glycol diacetate), glycols, fatty acid dimethylamides, fatty acids and fatty acid esters. In principle, solvent mixtures may also be used.

Suitable emulsifiers are nonionic and anionic emulsifiers (for example polyoxyethylene fatty alcohol ethers, alkylsulfonates and arylsulfonates).

Examples of dispersants are lignin-sulfite waste liquors and methylcellulose.

Suitable surfactants used are alkali metal, alkaline earth metal and ammonium salts of lignosulfonic acid, naphthalenesulfonic acid, phenolsulfonic acid, dibutylnaphthalenesulfonic acid, alkylarylsulfonates, alkyl sulfates, alkylsulfonates, fatty alcohol sulfates, fatty acids and sulfated fatty alcohol glycol ethers, furthermore condensates of sulfonated naphthalene and naphthalene derivatives with formaldehyde, condensates of naphthalene or of naphthalenesulfonic acid with phenol and formaldehyde, polyoxyethylene octylphenol ether, ethoxylated isooctylphenol, octylphenol, nonylphenol, alkylphenol polyglycol ethers, tributylphenyl polyglycol ether, tristearylphenyl polyglycol ether, alkylaryl polyether alcohols, alcohol and fatty alcohol ethylene oxide condensates, ethoxylated castor oil, polyoxyethylene alkyl ethers, ethoxylated polyoxypropylene, lauryl alcohol polyglycol ether acetal, sorbitol esters, lignosulfite waste liquors and methylcellulose.

Substances which are suitable for the preparation of directly sprayable solutions, emulsions, pastes or oil dispersions are mineral oil fractions of medium to high boiling point, such as kerosene or diesel oil, furthermore coal tar oils and oils of vegetable or animal origin, aliphatic, cyclic and aromatic hydrocarbons, for example toluene, xylene, paraffin, tetrahydronaphthalene, alkylated naphthalenes or their derivatives, methanol, ethanol, propanol, butanol, cyclohexanol, cyclohexanone, isophorone, highly polar solvents, for example dimethyl sulfoxide, N-methylpyrrolidone or water.

Also anti-freezing agents such as glycerin, ethylene glycol, propylene glycol and bactericides such as can be added to the formulation.

Suitable antifoaming agents are for example antifoaming agents based on silicon or magnesium stearate.

Suitable preservatives are for example dichlorophen und enzylalkoholhemiformal.

Seed Treatment formulations may additionally comprise binders and optionally colorants.

Binders can be added to improve the adhesion of the active materials on the seeds after treatment. Suitable binders are block copolymers EO/PO surfactants but also polyvinylalcoholsl, polyvinyl pyrrolidones, polyacrylates, polymethacrylates, polybutenes, polyisobutylenes, polystyrene, polyethyleneamines, polyethyleneamides, polyethyleneimines (Lupasol®, Polymin®), polyethers, polyurethans, polyvinylacetate, tylose and copolymers derived from these polymers.

Powders, materials for spreading and dustable products can be prepared by mixing or concomitantly grinding the active substances with a solid carrier.

Granules, for example coated granules, impregnated granules and homogeneous granules, can be prepared by binding the active compounds to solid carriers.

Examples of solid carriers are mineral earths such as silica gels, silicates, talc, kaolin, attaclay, limestone, lime, chalk, bole, loess, clay, dolomite, diatomaceous earth, calcium sulfate, magnesium sulfate, magnesium oxide, ground synthetic materials, fertilizers, such as, for example, ammonium sulfate, ammonium phosphate, ammonium nitrate, ureas, and products of vegetable origin, such as cereal meal, tree bark meal, wood meal and nutshell meal, cellulose powders and other solid carriers.

In general, the formulations comprise from 0.01 to 95% by weight, preferably from 0.1 to 90% by weight, of the active compound(s). In this case, the active compound(s) are employed in a purity of from 90% to 100% by weight, preferably 95% to 100% by weight (according to NMR spectrum).

For seed treatment purposes, respective formulations can be diluted 2-10 fold leading to concentrations in the ready to use preparations of 0.01 to 60% by weight active compound by weight, preferably 0.1 to 40% by weight.

The following are examples of formulations: 1. Products for dilution with water for foliar applications. For seed treatment purposes, such products may be applied to the seed diluted or undiluted.

### A) Water-Soluble Concentrates (SL, LS)

10 parts by weight of the active compound(s) are dissolved in 90 parts by weight of water or a water-soluble solvent. As an alternative, wetters or other auxiliaries are added. The active compound(s) dissolves upon dilution with water, whereby a formulation with 10% (w/w) of active compound(s) is obtained.

### B) Dispersible Concentrates (DC)

20 parts by weight of the active compound(s) are dissolved in 70 parts by weight of cyclohexanone with addition of 10 parts by weight of a dispersant, for example polyvinylpyrrolidone. Dilution with water gives a dispersion, whereby a formulation with 20% (w/w) of active compound(s) is obtained.

### C) Emulsifiable Concentrates (EC)

15 parts by weight of the active compound(s) are dissolved in 7 parts by weight of xylene with addition of calcium dodecylbenzenesulfonate and castor oil ethoxylate (in each case 5 parts by weight). Dilution with water gives an emulsion, whereby a formulation with 15% (w/w) of active compound(s) is obtained.

### D) Emulsions (EW, EO, ES)

25 parts by weight of the active compound(s) are dissolved in 35 parts by weight of xylene with addition of calcium dodecylbenzenesulfonate and castor oil ethoxylate (in each case 5 parts by weight). This mixture is introduced into 30 parts by weight of water by means of an emulsifier machine (e.g. Ultraturrax) and made into a homogeneous emulsion. Dilution with water gives an emulsion, whereby a formulation with 25% (w/w) of active compound(s) is obtained.

### E) Suspensions (SC, OD, FS)

In an agitated ball mill, 20 parts by weight of the active compound(s) are comminuted with addition of 10 parts by weight of dispersants, wetters and 70 parts by weight of water or of an organic solvent to give a fine active compound(s) suspension. Dilution with water gives a stable suspension of the active compound(s), whereby a formulation with 20% (w/w) of active compound(s) is obtained.

### F) Water-Dispersible Granules and Water-Soluble Granules (WG, SG)

50 parts by weight of the active compound(s) are ground finely with addition of 50 parts by weight of dispersants and wetters and made as water-dispersible or water-soluble granules by means of technical appliances (for example extrusion, spray tower, fluidized bed). Dilution with water gives a stable dispersion or solution of the active compound(s), whereby a formulation with 50% (w/w) of active compound(s) is obtained.

### G) Water-Dispersible Powders and Water-Soluble Powders (WP, SP, SS, WS)

75 parts by weight of the active compound(s) are ground in a rotor-stator mill with addition of 25 parts by weight of dispersants, wetters and silica gel. Dilution with water gives a stable dispersion or solution of the active compound(s), whereby a formulation with 75% (w/w) of active compound(s) is obtained.

2. Products to be applied undiluted for foliar applications. For seed treatment purposes, such products may be applied to the seed diluted

### I) Dustable Powders (DP, DS)

5 parts by weight of the active compound(s) are ground finely and mixed intimately with 95 parts by weight of finely divided kaolin. This gives a dustable product having 5% (w/w) of active compound(s)

### J) Granules (GR, FG, GG, MG)

0.5 part by weight of the active compound(s) is ground finely and associated with 95.5 parts by weight of carriers, whereby a formulation with 0.5% (w/w) of active compound(s) is obtained. Current methods are extrusion, spray-drying or the fluidized bed. This gives granules to be applied undiluted for foliar use.

### K) ULV Solutions (UL)

10 parts by weight of the active compound(s) are dissolved in 90 parts by weight of an organic solvent, for example xylene. This gives a product having 10% (w/w) of active compound(s), which is applied undiluted for foliar use.

Conventional seed treatment formulations include for example flowable concentrates FS, solutions LS, powders for dry treatment DS, water dispersible powders for slurry treatment WS, water-soluble powders SS and emulsion ES and EC and gel formulation GF. These formulation can be applied to the seed diluted or undiluted. Application to the seeds is carried out before sowing, either directly on the seeds.

In a preferred embodiment a FS formulation is used for seed treatment. Typically, a FS formulation may comprise 1-800 g/l of active ingredient, 1-200 g/l Surfactant, 0 to 200 g/l antifreezing agent, 0 to 400 g/l of binder, 0 to 200 g/l of a pigment and up to 1 liter of a solvent, preferably water.

Oils of various types, wetters, adjuvants, herbicides, fungicides, other pesticides, or bactericides may be added to the active compounds, even, if appropriate, not until immediately prior to use (tank mix). These agents are typically admixed with the compositions according to the invention in a weight ratio of from 1:10 to 10:1.

The note mentioning the effect of the active ingredients 1) and 2) in inducing tolerance to viruses may be present as a label on the packaging or in product data sheets. The note may also be present in the case of preparations, which can be used in combination with the active ingredients 1) and 2).

The induction of tolerance may also constitute an indication which may be the subject of official approval of the active ingredients 1) and 2).

### BIOLOGICAL EXAMPLES

### Use Example

### Preventive Action on Tomatoes against Viruses

The experiments were conducted under field conditions. Tomato seeds (variety: Carmen) were initially planted in seed boxes and transferred to the field, when having reached a height of about 10 cm. The plants were sufficiently watered and fertilized. Each seed box was treated 10, 20 and 28 days after seeding. The plants in the field were treated 7, 14 and 21 days after transfer to the field. Each treatment was carried out according to the plan listed below. The infection was naturally occurring, the phytopathogenic viruses have not been characterized.

Each treatment consisted out of four replications in an randomized experiment design. The virus attack was scored after 48 days after transplanting. The infected plant leaf area was scored in percentage.

Cabrio Top®, a commercial formulation of BASF Aktiengesellschaft, containing pyraclostrobin (5%) and metiram (55%) was used. The application was made at 400 g/100 l to run-off.

| | Seed box | | | Leaf Application | | |
|---|---|---|---|---|---|---|
| | 10 | | 28 | 7 | | |
| Trial No. | DAP | 20 DAP | DAP | DAT | 14 DAT | 21 DAT |
| 1 - Cabrio Top ® | X | X | X | . . . | . . . | . . . |
| 2 - Cabrio Top ® | X | X | X | X | X | X |
| 3 - Untreated control | . . . | . . . | . . . | . . . | . . . | . . . |

DAP = Days after Planting
DAT = Days after Transfer to the Field

The tomato plants which were treated only in the seed box (trial 1) showed 60% infested leaf area, the plants after seed box treatment and leaf application (trial 2) showed 34% infested leaf area, whereas the leaves of the untreated plants were infested by 74%.

The efficacy (E) is calculated as follows using Abbot's formula:

E=(1−α/β)·100

α corresponds to the fungal infection of the treated plants in % and
β corresponds to the fungal infection of the untreated (control) plants in %

An efficacy of 0 means that the infection level of the treated plants corresponds to that of the untreated control plants; an efficacy of 100 means that the treated plants were not infected.

The expected efficacies of mixtures of active compounds were determined using Colby's formula (Colby, S. R. “Calculating synergistic and antagonistic responses of herbicide combinations”, Weeds, 15, 20-22, 1967) and compared with the observed efficacies.

Colby's formula:

E=x+y−x·y/100

E expected efficacy, expressed in % of the untreated control, when using the mixture of the active compounds A and B at the concentrations a and b
x efficacy, expressed in % of the untreated control, when using the active compound A at the concentration a
y efficacy, expressed in % of the untreated control, when using the active compound B at the concentration b

1-21. (canceled)

22. A method of inducing virus tolerance of plants which comprises treating the plants, soil or seeds with an effective amount of a combination of
1) a compound of the formula I 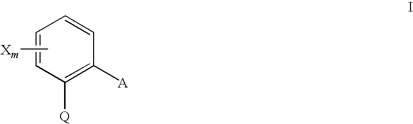
wherein
X is halogen, C₁-C₄-alkyl or trifluoromethyl;
m is 0 or 1;
Q is C(═CH—CH₃)—COOCH₃, C(═CH—OCH₃)—COOCH₃, C(═N—OCH₃)—CONHCH₃, C(═N—OCH₃)—COOCH₃, N(—OCH₃)—COOCH₃, or a group Q1 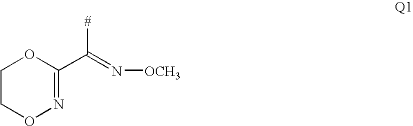
wherein # denotes a bond to the phenyl ring;
A is —O—B, —CH₂O—B, —OCH₂—B, —CH═CH—B, —C≡C—B, —CH₂O—N═C(R¹)—B, —CH₂O—N═C(R¹)—CH═CH—B, or —CH₂O—N═C(R¹)—C(R²)═N—OR³, where
B is phenyl, naphthyl, 5-membered or 6-membered hetaryl or 5-membered or 6-membered heterocyclyl, containing one to three N atoms and/or one O or S atom or one or two O and/or S atoms, the ring systems being unsubstituted or substituted by one to three radicals R^{a}:
R^{a} is cyano, nitro, amino, aminocarbonyl, aminothiocarbonyl, halogen, C₁-C₆-alkyl, C₁-C₆-haloalkyl, C₁-C₆-alkylcarbonyl, C₁-C₆-alkylsulfonyl, C₁-C₆-alkylsulfinyl, C₃-C₆-cycloalkyl, C₁-C₆-alkoxy, C₁-C₆-haloalkoxy, C₁-C₆-alkyloxycarbonyl, C₁-C₆-alkylthio, C₁-C₆-alkylamino, di-C₁-C₆-alkylamino, C₁-C₆-alkylaminocarbonyl, di-C₁-C₆-alkylaminocarbonyl, C₁-C₆-alkylaminothiocarbonyl, di-C₁-C₆-alkylaminothiocarbonyl, C₂-C₆-alkenyl, C₂-C₆-alkenyloxy, phenyl, phenoxy, benzyl, benzyloxy, 5- or 6-membered heterocyclyl, 5- or 6-membered hetaryl, 5- or 6-membered hetaryloxy, C(═NOR^{a})—R^{b} or OC(R^{a})₂—C(R^{b})═NOR^{b}, the cyclic radicals, in turn, being unsubstituted or substituted by one to three radicals R^{b}:
R^{b} is cyano, nitro, halogen, amino, aminocarbonyl, aminothiocarbonyl, C₁-C₆-alkyl, C₁-C₆-haloalkyl, C₁-C₆-alkylsulfonyl, C₁-C₆-alkylsulfinyl, C₃-C₆-cycloalkyl, C₁-C₆-alkoxy, C₁-C₆-haloalkoxy, C₁-C₆-alkoxycarbonyl, C₁-C₆-alkylthio, C₁-C₆-alkylamino, di-C₁-C₆-alkylamino, C₁-C₆-alkylaminocarbonyl, di-C₁-C₆-alkylaminocarbonyl, C₁-C₆-alkylaminothiocarbonyl, di-C₁-C₆-alkyl-aminothiocarbonyl, C₂-C₆-alkenyl, C₂-C₆-alkenyloxy, C₃-C₆-cycloalkyl, C₃-C₆-cycloalkenyl, phenyl, phenoxy, phenylthio, benzyl, benzyloxy, 5- or 6-membered heterocyclyl, 5- or 6-membered hetaryl, 5- or 6-membered hetaryloxy or C(═NOR^{A})-R^{B};
R^{A}, R^{B} are hydrogen or C₁-C₆-alkyl;
R¹ is hydrogen, cyano, C₁-C₄-alkyl, C₁-C₄-haloalkyl, C₃-C₆-cycloalkyl, C₁-C₄-alkoxy;
R² is phenyl, phenylcarbonyl, phenylsulfonyl, 5- or 6-membered hetaryl, 5- or 6-membered hetarylcarbonyl or 5- or 6-membered hetarylsulfonyl, the ring systems being unsubstituted or substituted by one to three radicals R^{a}, C₁-C₁₀-alkyl, C₃-C₆-cycloalkyl, C₂-C₁₀-alkenyl, C₂-C₁₀-alkynyl, C₁-C₁₀-alkylcarbonyl, C₂-C₁₀-alkenylcarbonyl, C₃-C₁₀-alkynylcarbonyl, C₁-C₁₀-alkylsulfonyl, or C(═NOR^{a})—R^{b}, the hydrocarbon radicals of these groups being unsubstituted or substituted by one to three radicals R^{c}:
R^{c} is cyano, nitro, amino, aminocarbonyl, aminothiocarbonyl, halogen, C₁-C₆-alkyl, C₁-C₆-haloalkyl, C₁-C₆-alkylsulfonyl, C₁-C₆-alkylsulfinyl, C₁-C₆-alkoxy, C₁-C₆-haloalkoxy, C₁-C₆-alkoxycarbonyl, C₁-C₆-alkylthio, C₁-C₆-alkylamino, di-C₁-C₆-alkylamino, C₁-C₆-alkylaminocarbonyl, di-C₁-C₆-alkylaminocarbonyl, C₁-C₆-alkylaminothiocarbonyl, di-C₁-C₆-alkylaminothiocarbonyl, C₂-C₆-alkenyl, C₂-C₆-alkenyloxy, C₃-C₆-cycloalkyl, C₃-C₆-cycloalkyloxy, 5- or 6-membered heterocyclyl, 5- or 6-membered heterocyclyloxy, benzyl, benzyloxy, phenyl, phenoxy, phenylthio, 5- or 6-membered hetaryl, 5- or 6-membered hetaryloxy or hetarylthio, it being possible for the cyclic groups, in turn, to be partially or fully halogenated or to have attached to them one to three radicals R^{a}; and
R³ is hydrogen, C₁-C₆-alkyl, C₂-C₆-alkenyl, or C₂-C₆-alkynyl, the hydrocarbon radicals of these groups being unsubstituted or substituted by one to three radicals R^{c}; and
2) a compound selected from the groups A) to N):
A) acylalanines: benalaxyl, metalaxyl, ofurace, oxadixyl,
B) amine derivatives: aldimorph, dodine, dodemorph, fenpropimorph, fenpropidin, guazatine, iminoctadine, spiroxamine, tridemorph,
C) anilinopyrimidines: pyrimethanil, mepanipyrim or cyprodinil,
D) antibiotics: cycloheximid, griseofulvin, kasugamycin, natamycin, polyoxin or streptomycin,
E) azoles: bitertanol, bromoconazole, cyproconazole, difenoconazole, dinitroconazole, enilconazole, epoxiconazole, fenbuconazole, fluquinconazole, flusilazole, flutriafol, hexaconazole, imazalil, ipconazole, metconazole, myclobutanil, penconazole, propiconazole, prochloraz, prothioconazole, simeconazole, tebuconazole, tetraconazole, triadimefon, triadimenol, triflumizol, triticonazole,
F) dicarboximides: iprodione, myclozolin, procymidone, vinclozolin,
G) dithiocarbamates: ferbam, nabam, maneb, mancozeb, metam, metiram, propineb, polycarbamate, thiram, ziram, zineb,
H) heterocyclic compounds: anilazine, benomyl, boscalid, carbendazim, carboxin, oxycarboxin, cyazofamid, dazomet, diflufenzopyr, dithianon, famoxadone, fenamidone, fenarimol, fuberidazole, flutolanil, furametpyr, isoprothiolane, mepronil, nuarimol, penthiopyrad, picobenzamid, probenazole, proquinazid, pyrifenox, pyroquilon, quinoxyfen, silthiofam, thiabendazole, thifluzamide, thiophanate-methyl, tiadinil, tricyclazole, triforine, 5-chloro-7-(4-methyl-piperidin-1-yl)-6-(2,4,6-trifluoro-phenyl)-[1,2,4]triazolo[1,5-a]pyrimidine, 4-Difluoromethyl-2-methyl-thiazole-5-carboxylic acid-(4′-bromo-biphenyl-2-yl)-amide, 4-Difluoromethyl-2-methyl-thiazole-5-carboxylic acid-(4′-trifluoromethyl-biphenyl-2-yl)amide, 4-Difluoromethyl-2-methyl-thiazole-5-carboxylic acid-(4′-chloro-3′-fluoro-biphenyl-2-yl)-amide, 3-Difluoromethyl-1-methyl-pyrazole-4-carboxylic acid-(3′,4′-dichloro-4-fluoro-biphenyl-2-yl)-amide, 3-Difluoromethyl-1-methyl-pyrazole-4-carboxylic acid-(3′,4′-dichloro-5-fluoro-biphenyl-2-yl)-amide, 3,4-Dichloro-isothiazole-5-carboxylic acid (2-cyano-phenyl) amide, 3-[5-(4-Chloro-phenyl)-2,3-dimethyl-isoxazolidin-3-yl]-pyridine, 2-Butoxy-6-iodo-3-propyl-chromen-4-one, 3-(3-Bromo-6-fluoro-2-methyl-indole-1-sulfonyl)-[1,2,4]triazole-1-sulfonic acid dimethylamide, (2-Chloro-5-[1-(3-methyl-benzyloxyimino)-ethyl]-benzyl)carbamic acid methyl ester, (2-Chloro-5-[1-(6-methyl-pyridin-2-ylmethoxyimino)-ethyl]-benzyl)-carbamic acid methyl ester,
I) sulfur, and copper fungicides, such as Bordeaux mixture, copper acetate, copper oxychloride, basic copper sulfate,
J) nitrophenyl derivatives: binapacryl, dinocap, dinobuton, nitrophthalisopropyl,
K) phenylpyrroles: fenpiclonil or fludioxonil,
L) other fungicides, seleced from acibenzolar-5-methyl, benthiavalicarb, carpropamid, chlorothalonil, cyflufenamid, cymoxanil, diclomezin, diclocymet, diethofencarb, edifenphos, ethaboxam, fenhexamid, fentin acetate, fenoxanil, ferimzone, fluazinam, phosphorous acid and its alkali- and earth alkali salts, fosetyl, fosetyl-aluminum, iprovalicarb, hexachlorobenzene, mandipropamid, metrafenone, pencycuron, propamocarb, phthalide, toloclofos-methyl, quintozene, zoxamid, N-(2-(4-[3-(4-Chloro-phenyl)-prop-2-ynyloxy]-3-methoxy-phenyl)-ethyl)-2-methanesulfonylamino-3-methyl-butyramide, N-(2-(4-[3-(4-Chlorophenyl)-prop-2-ynyloxy]-3-methoxy-phenyl)-ethyl)-2-ethanesulfonylamino-3-methyl-butyramide, 3-(4-Chloro-phenyl)-3-(2-isopropoxy carbonylamino-3-methyl-butyrylamino)-propionic acid methyl ester,
M) sulfenic acid derivatives: captafol, captan, dichlofluanid, folpet, tolylfluanid, and
N) cinnamides and analogous compounds: dimethomorph, flumetover or flumorph,
wherein active compounds 1) and 2) are taken up by the plants or the seeds thereby inducing virus tolerance of the plants.

23. The method of claim 22, wherein compound 1) is selected from the group consisting of: pyraclostrobin, kresoxim-methyl, dimoxystrobin, 2-(ortho-((2,5-Dimethylphenyl-oxymethylene)phenyl)-3-methoxy-acrylic acid methyl ester, picoxystrobin, trifloxystrobin, enestroburin, orysastrobin, metominostrobin, azoxystrobin, and fluoxastrobin.

24. The method of claim 22, wherein compound 1) is selected from the group consisting of: azoxystrobin, pyraclostrobin, and picoxystrobin.

25. The method of claim 22, wherein compound 1) is pyraclostrobin.

26. The method of claim 22, wherein compound 2) is selected from the group consisting of: benalaxyl, metalaxyl, ofurace, and oxadixyl.

27. The method of claim 22, wherein compound 2) is selected from the group consisting of: dodine, fenpropimorph, and tridemorph.

28. The method of claim 22, wherein compound 2) is selected from the group consisting of: epoxiconazole, fluquinconazole, flutriafol, metconazole, prochloraz, tebuconazole, and triticonazole.

29. The method of claim 22, wherein compound 2) is selected from the group consisting of: ferbam, nabam, maneb, mancozeb, metam, metiram, propineb, polycarbamate, thiram, ziram, and zineb.

30. The method of claim 22, wherein compound 2) is selected from the group consisting of: anilazine, benomyl, boscalid, carbendazim, carboxin, oxycarboxin, cyazofamid, dithianon, flutolanil, thiabendazole, thiophanate-methyl, and 5-chloro-7-(4-methyl-piperidin-1-yl)-6-(2,4,6-trifluoro-phenyl)-[1,2,4]triazolo[1,5-a]pyrimidine.

31. The method of claim 22, wherein compound 2) is selected from the group consisting of: acibenzolar-5-methyl, benthiavalicarb, chlorothalonil, cyflufenamid, cymoxanil, phosphorous acid and its salts, and metrafenone.

32. The method of claim 22, wherein compound 2) is selected from the group consisting of: captan, and folpet.

33. The method of claim 22, wherein compound 2) is selected from the group consisting of: dimethomorph and flumorph.

34. The method of claim 22, wherein the compounds 1) and 2) are applied in synergistically effective amounts during treatment.

35. The method of claim 22, wherein compounds 1) and 2) are applied in ratios of from 100:1 to 1:100 during treatment.

36. The method of claim 22, wherein treatment with compounds 1) and 2) is carried out shortly after germination of the plants.

37. The method of claim 22, wherein treatment with compounds 1) and 2) is carried out during the first six weeks of a growth period of the plants.

38. The method of claim 22, wherein treatment with compounds 1) and 2) is carried out one to ten times before expected virus attack.

39. The method of claim 35, wherein repeated application of compounds 1) and 2) is made every 10 to 20 days.

40. The method of claim 22, wherein compounds 1) and 2) are applied to potato or tomato plants during treatment.

41. The method of claim 22, wherein compounds 1) and 2) are applied to seeds during treatment.
